(19) United States
(12) Patent Application Publication
(10) Pub. No.: US 2010/0070644 A1
(43) Pub. Date: Mar. 18, 2010

(54) APPARATUS AND METHOD FOR TIME-SHIFT SERVICE BASED ON MULTIMEDIA INFORMATION, APPARATUS FOR REPRODUCING MULTIMEDIA USING THE SAME

(76) Inventors: Seong-Yong Lim, Daejon (KR); Ji-Hoon Choi, Daejon (KR); Hyun-Cheol Kim, Daejon (KR); Joo-Myoung Seok, Daejon (KR); Han-Kyu Lee, Daejon (KR); Jin-Woo Hong, Daejon (KR)

Correspondence Address: LADAS & PARRY LLP, 224 SOUTH MICHIGAN AVENUE, SUITE 1600, CHICAGO, IL, 60604, US

(21) Appl. No.: 12/517,402

(22) PCT Filed: Dec. 3, 2007
(86) PCT No.: PCT/KR07/06208

§ 371 Date: Nov. 16, 2009

(30) Foreign Application Priority Data
Dec. 4, 2006 (KR) 10-2006-0121437
Aug. 31, 2007 (KR) 10-2007-0088332

(51) Int. Cl. G06F 15/16

(52) U.S. Cl. 709/231; 709/234

(57) ABSTRACT

Provided are a time shift service apparatus and method based on multimedia information, and a multimedia reproducing apparatus using the same. The timeshift service apparatus includes: a timeshift buffering unit for storing a multimedia stream according a timeshift service requested from an outside device; a time obtaining unit for obtaining time information about times of starting and ending a timeshift service according to the timeshift service request; a memory managing unit for storing a multimedia stream, which is serviced based on the obtained time information by the time obtaining unit, in the timeshift buffering unit; and an information generating unit for generating detailed information for the multimedia stream stored in the timeshift buffering unit.

### TECHNICAL FIELD

The present invention relates to an apparatus and method for time shift service based on multimedia information, and an apparatus for reproducing multimedia using the same; and, more particularly, to an apparatus and method for time shift service based on multimedia information, and an apparatus for reproducing multimedia using the same, which enable a user to accurately and conveniently search and reproduce a multimedia stream by storing a multimedia stream that is received in real time according to a request of a time shift service from a user, and generating and providing detailed information of the stored multimedia stream to a user.

This work was supported by IT R & D program of MIC/IITA [2005-S-403-02, “Development of Super-intelligent Multimedia Anytime-anywhere Realistic TV (SmarTV) Technology”].

### BACKGROUND ART

In general, a multimedia stream means a successive data flow including audio, video, and auxiliary data, which is transmitted through a broadcasting network and a communication network.

An apparatus for receiving and reproducing the multimedia stream supports a function of storing and reproducing a stream through an internal memory or an external memory. The apparatus for receiving and reproducing the multimedia stream is referred as a reproducing apparatus. Also, the reproducing apparatus can store a real-time stream and reproduce the stored stream at the same time.

The function of storing a real-time stream and reproducing the stored stream at the same time is referred as a timeshift service.

Generally, the reproducing apparatus can perform a rewind operation, a forward operation, and a play operation at a predetermined past time according to a user's request while reproducing the real-time stream of the timeshift service.

Meanwhile, a method for describing auxiliary data contents was introduced in order to describe multimedia contents in detail.

The method for describing the auxiliary data contents can define channel information about a physical or a logical channel, information about program organization, detailed information about a program, and information about segments in a program.

The auxiliary metadata of TV-Anytime included in the European Telecommunications Standards Institute (ETSI) includes program organization information, program time information, and segment time information.

However, functions for a timeshift service according to the related art were not applicable for programs or segments stored in a timeshift buffer.

That is, it was impossible to search locations of programs and segments stored in the timeshift buffer because information about programs and segment stored in a timeshift buffer was not used.

### DISCLOSURE OF INVENTION

### Technical Problem

In the related art, a user could not accurately and conveniently search programs or segments to reproduce because a user was not aware of the detailed information about an object to receive, record, and reproduce. Therefore, it is an aspect of the present invention to solve such a problem of the related art.

An embodiment of the present invention is directed to providing an apparatus and method for time shift service based on multimedia information, and an apparatus for reproducing multimedia using the same, which enable a user to accurately and conveniently search and reproduce a multimedia stream by storing a multimedia stream that is received in real time according to a request of a time shift service from a user and generating and providing detailed information of the stored multimedia stream to a user.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a timeshift service apparatus including: a timeshift buffering unit for storing a multimedia stream according a timeshift service requested from an outside device; a time obtaining unit for obtaining time information about times of starting and ending a timeshift service according to the timeshift service request; a memory managing unit for storing a multimedia stream, which is serviced based on the obtained time information by the time obtaining unit, in the timeshift buffering unit; and an information generating unit for generating detailed information for the multimedia stream stored in the timeshift buffering unit.

In accordance with another aspect of the present invention, there is provided a multimedia reproducing apparatus for a timeshift service including: a receiving and reproducing unit for receiving a multimedia stream and reproducing the received multimedia stream; a media storming unit for storing the received multimedia stream; a stream analyzing unit for obtaining time information about a timeshift service by analyzing the received multimedia stream according to a timeshift service start request, extracting a multimedia stream serviced based on the obtained time information, and storing the extracted multimedia stream in the media storing unit; a media information storing unit for storing detailed information for the received multimedia stream; and an information generating unit for generating detailed information for a multimedia stream stored in the media storing unit.

In accordance with another aspect of the present invention, there is provided a timeshift service method including the steps of: obtaining time information about a timeshift service start time and a timeshift service end time according to a timeshift service request; storing a multimedia stream, which is serviced based on the obtained time information in the obtaining time information; and generating detailed information for the multimedia stream stored in the storing a multimedia stream.

In accordance with another aspect of the present invention, there is provided a method for storing a multimedia stream and generating information thereof for a timeshift service, including the steps of: starting to store a multimedia stream in a timeshift buffering unit when a timeshift starts; generating information of a multimedia stream stored in the timeshift buffering unit; and ending to store a multimedia stream stored in the timeshift buffering unit according to a request of ending a timeshift.

### ADVANTAGEOUS EFFECTS

According to the present invention, a user can be aware of the detailed information about a timeshift stream including the time information of the timeshift stream to reproduce by providing a timeshift service with the detailed information thereof.

Also, a user is enabled to reproduce a timeshift stream using the detailed information of a timeshift stream by providing the timeshift service with the detailed information thereof according to the present invention. Therefore, the user can accurately and conveniently search a timeshift to reproduce.

Furthermore, a timeshift service apparatus and method based on multimedia information, and a multimedia reproducing apparatus using the same according to the present invention can be applied to broadcasting related fields such as digital multimedia broadcasting (DMB) and various technical fields related to a multimedia stream such as Radio. Therefore, a user can easily search a multimedia stream.

### BRIEF DESCRIPTION OF THE DRAWINGS

FIG. 1 is a block diagram illustrating a timeshift service apparatus in accordance with an embodiment of the present invention.

FIG. 2 is a diagram illustrating a method for obtaining information about a time of a timeshift service of a timeshift service apparatus in accordance with an embodiment of the present invention.

FIG. 3 is a diagram for describing a method for obtaining information about a time of a timeshift service of a timeshift service apparatus in accordance with another embodiment of the present invention.

FIG. 4 is a flowchart illustrating a timeshift service method for a timeshift service apparatus in accordance with an embodiment of the present invention.

FIG. 5 is a flowchart illustrating a method for generating and storing a multimedia stream of a timeshift service apparatus in accordance with an embodiment of the present invention.

FIG. 6 is a diagram illustrating a method for storing a multimedia stream and generating timeshift information of a timeshift service apparatus in accordance with an embodiment of the present invention.

FIG. 7 is a block diagram illustrating a multimedia reproducing apparatus for a timeshift service in accordance with an embodiment of the present invention.

### MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

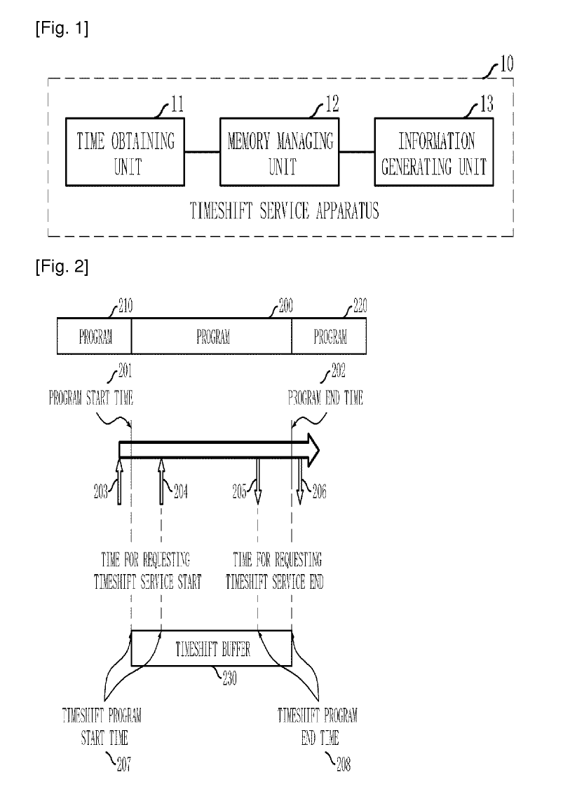

FIG. 1 is a block diagram illustrating a timeshift service apparatus in accordance with an embodiment of the present invention.

As shown in FIG. 1, the timeshift service apparatus 10 includes a time obtaining unit 11, a memory managing unit 12, and an information generating unit. The time obtaining unit 11 obtains time information about a start time and an end time for starting and ending a timeshift service according to a corresponding request from a user. The memory managing unit 12 starts to store a multimedia stream broadcasted at the timeshift service start time obtained at the time obtaining unit 11 and ends to store the multimedia stream in a timeshift buffer 230 in FIG. 2 at the timeshift service end time obtained by the time obtaining unit 11. The information generating unit 13 generates detailed information for the multimedia stream stored in the timeshift buffer 230 in FIG. 2.

The information generating unit 13 reprocesses detailed multimedia stream information, which is obtained from or previously stored in an external device or an external module such as a broadcasting server, in order to provide the detailed multimedia stream information to a user rather than newly generating the detailed multimedia stream information

Here, the information generating unit 13 may generate information about channel units, program units, and segment units of each multimedia stream stored in a timeshift buffer 230 in FIG. 2. Also, the time information may be included in the detailed multimedia stream information

For example, if a multimedia stream stored in the timeshift buffer 230 of FIG. 2 is a program broadcasted at 9 o'clock from an MBC broadcasting station which is one of major broadcasting stations in South Korea, the information generating unit 13 may generate channel information about a channel ‘MBC channel’ generate program information about a program ‘MBC evening News’ and generate segment information about one of program corners ‘Traffic report’ or ‘Weather forecast’.

The information generating unit 13 may also generate time information at a predetermined time interval for a program broadcasted at 9 o'clock from the MBC, and the generated time information can be displayed through a progress bar or instant image capturing.

The information generating unit 13 may also generate detailed information about channels, programs, and segments.

The detailed information of a channel ‘MBC’ may be information for describing the MBC broadcasting station. For example, the detailed information of the channel ‘MBC’ is that ‘a terrestrial broadcasting station at Seoul’ or ‘CEO of MBC is Mr. MoonSoon Choi’. The detailed information of a program may be information about the program of ‘MBC evening news’. For example, the detailed information of the program is that ‘anchors of MBC evening news are Mr. Ki-joeng Eom, Miss Hey-jin Park, and Miss Ju-ha Kim’. The detailed information of a segment may be information about program corners such as ‘traffic report’ or ‘weather forecast’. For example, the detailed information of the segment is that ‘traffic report provides the traffic information of I-495 and I-66 ’ or ‘weather forecast provides today's weather and weather for weekends’.

FIG. 2 is a diagram illustrating a method for obtaining time information of a timeshift service in a timeshift service apparatus in accordance with an embodiment of the present invention.

In FIG. 2, it is assumed that a multimedia stream include a plurality of program units.

If a user requests to start a timeshift service at a time 203 which is faster than an actual broadcasting start time 201 of a corresponding program 200, the timeshift service apparatus 10 regards the timeshift program start time 207 of the program 200 stored in the timeshift buffer 230 as the actual broadcasting start time 201 of the program 200.

If a user requests to start a timeshift service at a time 204 that is later than an actual broadcasting start time 201 of a corresponding program 200, the timeshift service applauds 10 regards a timeshift program start time 207 of the program 200 stored in the timeshift buffer 230 as a requested time 204 for starting the timeshift service from a user.

Meanwhile, if a user requests to end a timeshift service at a time 205 which is faster than an actual broadcasting end time 202 of a corresponding program 200, the timeshift service apparatus 10 regards a timeshift program end time 208 for the program 200 stored in the timeshift buffer 230 as a requested time 205 for ending a timeshift service from a user.

If a user requests to end a timeshift service at a time 206 which is later than an actual broadcasting end time 202 of a corresponding program 200, the timeshift service apparatus 10 regards the timeshift program end time 208 for the program 200 stored in the timeshift buffer 230 as the actual broadcasting end time 202 of the program 200.

As described above, the timeshift service apparatus can obtain the timeshift service time information of a part or entire program 200, which is stored in the timeshift buffer 230, in order to provide a timeshift service to a user.

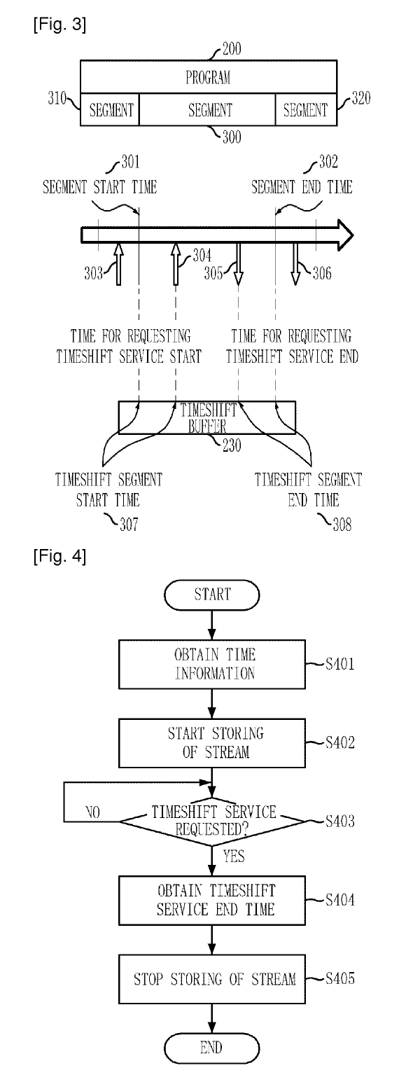

FIG. 3 is a diagram for describing a method for obtaining information about a time of a timeshift service of a timeshift service apparatus in accordance with another embodiment of the present invention.

In FIG. 3, it is assumed that a multimedia stream include a plurality of segment units.

If a user requests to start a timeshift service at a time 303 which is faster than an actual broadcasting start time 301 of a corresponding segment 300, the timeshift service apparatus 10 regards a timeshift segment start time 307 of the segment 300 stored in a timeshift buffer 230 as the actual broadcasting start time 301 of the segment 300.

And, if a user requests to start a timeshift service at a time 304 which is later than an actual broadcasting start time 301 of a segment 300, the timeshift service apparatus 10 regards a timeshift segment start time 307 for the segment stored in the timeshift buffer 230 as a requested time 304 for starting a timeshift service from a user.

If a user requests to end a timeshift service at a time 305 which is faster than an actual broadcasting end time 302 of a segment 300, the timeshift service apparatus 10 regards a timeshift segment end time 308 for the segment 300 stored in the timeshift buffer 230 as a requested time for ending a timeshift service.

If a user requests to end a timeshift service at a time 306 which is later than an actual broadcasting end time 302 of the segment 300, the timeshift service apparatus 10 regards a timeshift segment end time 308 for a segment stored in the timeshift buffer 230 as an actual broadcasting end time 302 of the segment 300.

As described above, the timeshift service apparatus 10 according to the present embodiment can obtain timeshift service time information of some or entire segments of a program 200, which are stored in the timeshift buffer 230, for providing a timeshift service to a user.

Although the unit of a multimedia stream was described as a program unit or a segment unit in FIGS. 2 and 3, the present invention is not limited thereto.

FIG. 4 is a flowchart illustrating a timeshift service method of a timeshift service apparatus in accordance with an embodiment of the present invention.

At step S401, the timeshift service apparatus 10 obtains time information for starting and ending a timeshift service according to a request for starting and ending a timeshift service from a user.

Here, the timeshift service apparatus 10 according to the present embodiment uses the method shown in FIGS. 2 and 3 to obtain the time information.

The timeshift service apparatus 10 starts storing of a multimedia stream broadcasted at the obtained timeshift service start time from the timeshift buffer at step S402.

Here, the timeshift service apparatus 10 may generate detailed information for a corresponding multimedia stream at the same time of storing the multimedia stream in the timeshift buffer or may generate detailed information of a multimedia stream, which is timeshift stream, stored in a timeshift buffer independently from storing the multimedia stream in the timeshift buffer. However, the present invention is not limited thereto.

The timeshift service apparatus 10 determines whether a user requests to end a timeshift service or not at step S403. If the user requests to end the timeshift service at step S403, the timeshift service apparatus 10 obtains a corresponding timeshift service end time at step S404 and ends the storing of the multimedia stream stored in the timeshift buffer at the obtained timeshift service end time at step S405.

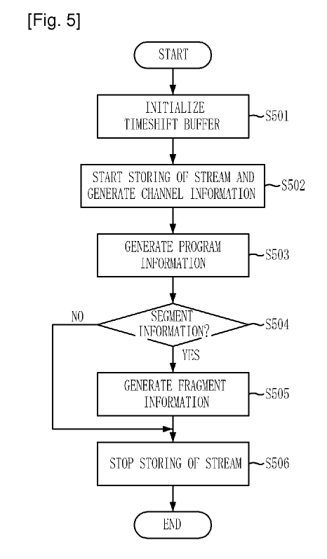

FIG. 5 is a flowchart illustrating a method for generating and storing a multimedia stream of a timeshift service apparatus in accordance with an embodiment of the present invention.

At step S501, the timeshift service apparatus 10 according to the present embodiment initializes a timeshift buffer when a timeshift starts.

Here, the timeshift may start automatically by turning on the timeshift service apparatus 10 by a user, or the timeshift may start by directly requesting to start the timeshift service through a timeshift mode button. However, the present invention is not limited thereto.

Then, the timeshift service apparatus 10 starts to store a multimedia stream, which is reproduced at a current channel, in the initialized timeshift buffer. Otherwise, the timeshift service apparatus 10 starts to store a multimedia stream, which is reproduced at an assigned channel at an assigned time by a user, and generate channel information of a multimedia stream (timeshift stream) that is stored in the timeshift buffer at step S502.

Here, the timeshift channel information is information about a current channel. For example, the timeshift channel information may be information about the name and the description of a channel in a current timeshift stream such as ‘the current reproduced channel is MBC’, ‘MBC is a terrestrial broadcasting station in Seoul’, and ‘CEO thereof is Mr. MoonSoon Chio’. Or, the timeshift channel information may include time information such as a timeshift channel start time and a timeshift channel end time.

At step S503, the timeshift service apparatus 10 generates the program information of a multimedia stream being stored in the timeshift buffer, which is the timeshift stream being stored in the timeshift buffer.

Here, the timeshift program information denotes information about a program requested by a user. For example, the timeshift program information may be information about the name and the description of a program such as ‘MBC evening news’ and ‘anchors of MBC evening news are Mr. Ki-young Eom, Miss Hye-jin Park, and Miss Ju-ha Kim’. Also, the timeshift program information may include time information about a timeshift program start time and a timeshift program end time.

At step S504, the timeshift service apparatus 10 determines whether or not a multimedia stream being stored in the timeshift buffer includes segment information. If the multimedia stream includes the segment information, the timeshift service apparatus 10 generates timeshift segment information as low level information of timeshift program information at step S505. Then, the timeshift service apparatus 10 stops to store the timeshift stream at step S506.

Here, the timeshift segment information denotes information about corners in a program that is requested by a user. For example, the timeshift segment information may be information about the names or the descriptions of corners such as ‘traffic report’, ‘today's weather’, or ‘today's weather provide current weather information and forecast weather of weekends’. The timeshift segment information may include time information about a timeshift segment start time and a timeshift segment end time.

Meanwhile, if the segment information is not included at step S504, the timeshift service apparatus 10 does not generate timeshift segment information and the step S506 is progressed.

If it is requested to end a timeshift service, the timeshift service apparatus 10 according to the present embodiment stops to store the multimedia stream (timeshift stream) being stored in the timeshift buffer at step S506.

Here, the timeshift service may automatically end by turning off the timeshift service apparatus 10 by a user. Or the timeshift service may end by directly requesting to end the timeshift service through a timeshift mode button by a user. However, the present invention is not limited thereto.

Here, the timeshift service apparatus 10 may generate information about a multimedia stream at the same time of storing the multimedia stream in a timeshift buffer. Or the timeshift service apparatus 10 may generate information about a stored multimedia stream after storing a multimedia stream in a timeshift buffer.

In the present embodiment, the method for storing and generating a multimedia stream for a timeshift service of the timeshift service apparatus 10 was described to perform related operation in an order that a channel start before a program and a program starts before a segment, that is, from an upper level to a lower level. However, the present invention is not limited thereto. That is, the method for storing and generating a multimedia stream according to the present embodiment can be applicable although the other program start after one program or the other segment starts after one segment. That is, the same operation may be repeatedly performed in the method for storing and generating a multimedia stream according to the present embodiment.

In FIG. 5, the timeshift service apparatus 10 generates information about a multimedia stream stored for a timeshift service in an order of channel information, program information, and segment information. However, the present invention is not limited thereto. Although a new event is generated while storing the multimedia stream, the timeshift service apparatus 10 can start to process the newly generated event after interrupting a current processing event. Here, the new event may be an event of changing a channel change, an event of starting a new program, an event of starting a new subprogram (segment), or an event of requesting to end a current process.

For example, if a user requests the timeshift service apparatus 10 to change a channel while the timeshift service apparatus 10 generates timeshift channel information, timeshift program information, or timeshift segment information, the timeshift service apparatus 10 interrupts to store the current multimedia stream and starts to store a multimedia stream reproduced at the requested channel. Then, the timeshift service apparatus 10 generates new timeshift channel information, new timeshift program information, and new timeshift segment information for the new multimedia stream.

Here, if the multimedia stream reproduced at the changed channel does not include segment information, the timeshift service apparatus 10 does not generate timeshift segment.

FIG. 6 is a diagram illustrating a method for storing a multimedia stream and generating timeshift information of a timeshift service apparatus in accordance with an embodiment of the present invention.

In FIG. 6, the timeshift service apparatus 10 according to the present embodiment is described to generate information about a corresponding timeshift stream while storing the timeshift stream in a timeshift buffer 600. However, the present invention is not limited thereto. That is, the timeshift service apparatus 10 may additionally generate information about a timeshift stream stored in a timeshift buffer after completely storing the timeshift stream in the timeshift buffer. Or, the timeshift service apparatus 10 may additionally generate corresponding information when a user requests information about a timeshift stream.

At first, if a timeshift service starts while a first program of a first channel is being reproducing, the timeshift service apparatus 10 generates information about the first channel that is reproduced, stores the first program reproduced at the first channel in the timeshift buffer 600, and generates information about the first program from a time 601 of starting the timeshift service.

If the first program includes a segment 1-1, the timeshift service apparatus 10 generates segment-unit information from a time 602 of starting the segment 1-1 while storing the first program in the timeshift buffer 600.

Then, the timeshift service apparatus 10 ends to store the segment 1-1 and the first program in the timeshift buffer 600 and simultaneously generates the end-storing information of the segment 1-1 and the first program at a time 603 of ending the segment 1-1 and the first program.

From a time 604 of starting a second program, the timeshift service apparatus 10 starts to store the second program in the timeshift buffer 600 and generates information about the second program including the start-storing information of the second program at the same time.

At a time 605 of ending a segment 2-1, the timeshift service apparatus 10 ends to store the segment 2-1 in the timeshift buffer 600 and generates the end-storing information of the segment 2-1, simultaneously. From a time 606 of starting a segment 2-2, the timeshift service apparatus 10 starts to store the segment 2-2 in the timeshift buffer 600 and generates the information about the segment 2-2 including the start-storing information at the same time.

At a time 607 of ending the segment 2-2, the timeshift service apparatus 10 ends to store the segment 2-2 in the timeshift buffer 600 and generates the end information of the segment 2-2, simultaneously. From the time 607 of ending a segment 2-2, the timeshift service apparatus 10 generates program-unit information because the second program includes no more segment information.

The timeshift service apparatus 10 ends to store the second program and simultaneously generates the end information of the second program at a time 608 of ending the second program.

From a time 609 of starting the third program, the timeshift service apparatus 10 starts to store the third program in the timeshift buffer 600 and generates the information of the third program including the start-storing information thereof at the same time.

When the timeshift service ends at a time 610, the timeshift service apparatus 10 ends to store the third program in the timeshift buffer 600 and generates the end-storing information of the third program at the same time. Also, the timeshift service apparatus 10 generates the end-storing information of the first channel.

Although time information was not shown in FIG. 6, the timeshift service apparatus 10 may generate the information of a timeshift stream including the time information about start-times and end-times of channels, programs, and segments.

Hereinafter, a procedure of providing a timeshift service from a timeshift service apparatus 10 to a user will be described.

A user can obtain the information of multimedia streams such as timeshift streams stored in the timeshift buffer 600, like the first program, the segment 1-1, the second program, the segment 2-1 and the segment 2-2 of the second program, and the third program shown in FIG. 6.

If a user wants to watch the segment 2-2 of the second program among the timeshift stream, the user can select and watch a part corresponding to the segment 2-2 among the information of the timeshift stream provided from the timeshift service apparatus 10.

Here, if the timeshift service apparatus 10 provides the detailed time information of the timeshift stream with the timeshift stream, a user may select a desired part of the detailed information among the segment 2-2 and watch a corresponding scene.

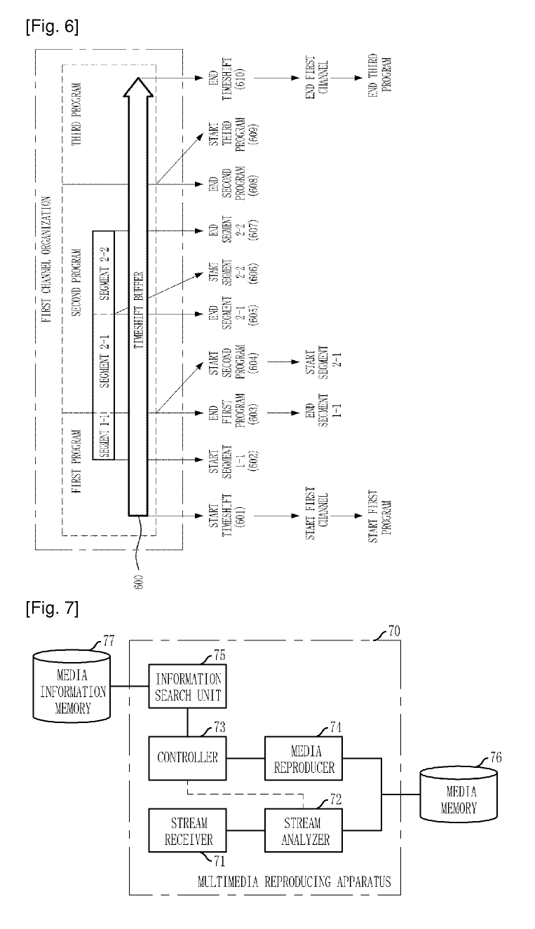

FIG. 7 is a block diagram illustrating a multimedia reproducing apparatus for a timeshift service in accordance with an embodiment of the present invention.

Referring to FIG. 7, the multimedia reproducing apparatus 70 includes a stream receiver 71, a stream analyzer 72, a controller 73, a media reproducer 74, and a media information search unit 75.

The multimedia reproducing apparatus 70 for a timeshift service according to the present embodiment may further include a media memory 76 and a media information memory 77.

Hereinafter, the configuration and the operations of the multimedia reproducing apparatus 70 according to the present embodiment will be described in more detail.

The stream receiver 71 receives a multimedia stream where audio signal and video signal are combined in real time based on a predetermined scheme corresponding to the type of a transmission network.

The stream receiver 71 may receive the multimedia stream from an external apparatus or an external module such as a broadcasting server.

The stream analyzer 72 analyzes the multimedia stream received through the stream receiver 71. Then, the stream analyzer 71 transfers a multimedia stream broadcasted in real time to the media reproducer 74 and transfers a multimedia stream corresponding to a timeshift service requested from an application (not shown) in the media memory 76.

Here, if an application requests a timeshift service, the stream analyzer 72 obtains the time information of the timeshift service, extracts or filters a multimedia stream broadcasted at a time corresponding to the obtained time information, and stores the extracted multimedia stream in the media memory 76.

Since the stream analyzer 72 uses the same method described with reference to FIGS. 2 and 3 to obtain the time information of the timeshift service, the detailed description thereof is omitted.

If an application requests to provide a timeshift service, the stream analyzer 72 transmits the location information of a multimedia stream, which is a timeshift stream, stored in the media memory 76 to the media reproducer 74.

Here, the media memory 76 is a storage device for temporally or permanently storing the multimedia stream extracted or filtered by the stream analyzer 72. The media memory 76 may be disposed inside the multimedia reproducing apparatus 70 or externally disposed.

The controller 73 requests to the media information memory 76 to provide information about a multimedia stream that is requested for generating the detailed information of a multimedia stream stored in the media memory 76. Here, the multimedia stream is the timeshift stream.

Also, the controller 73 generates the detailed information about the timeshift stream based on the information about the multimedia stream searched and transmitted by the media information search unit 75 and transmits the generated detailed information to the media reproducer 74.

Here, the controller 73 uses the same method used in the information generator 13 in FIG. 1 to generate the detailed information about a timeshift stream. Therefore, the detailed description of the method for generating the detail information is omitted.

The media information search unit 75 searches and extracts the information about a multimedia stream requested by the controller 73 from the media information memory 77 and transmits the extracted information to the controller 73.

The media information search unit 75 searches the program unit detailed information and the segment unit detailed information of a multimedia stream and location information by classifying the multimedia stream in detail.

The media information memory 77 is a storage device for storing information about a multimedia stream. The media information memory 77 may be disposed inside the multimedia reproducing apparatus 70 and externally disposed as a stand-alone device.

The information about the multimedia stream may include channel information, program group information, program information, segment information, and time information of a multimedia stream. Such information may be stored in the media information memory 77 before the information is searched the media information search unit 75. Or, the information may be transmitted from an external apparatus or an external module such as a broadcasting server to the media information memory 77 and stored in the media information memory 77 according to a search request of the media information search unit 75.

The media reproducer 74 decodes and reproduces a real-time multimedia stream transmitted from the stream analyzer 72.

The media reproducer 74 decodes and reproduces a corresponding multimedia stream stored in the media memory 76 according to the detailed information of a timeshift stream transmitted from the controller 73.

Although it is described that the stream analyzer 72 obtains timeshift service time information requested from an application in FIG. 7, the present invention is not limited thereto. The controller 73, a predetermined module, or a dedicated module (not shown) for controlling timeshift information may obtain timeshift service time information requested from an application and transmit an storing instruction to the stream analyzer 72 based on the obtained timeshift service time information.

A step of performing a timeshift service, a step for storing a multimedia stream, and a step of generating the information of a multimedia stream of the multimedia reproducing apparatus 70 can be embodied by adding a step of reproducing into the timeshift service step, the multimedia stream storing step, and the information generating step of the timeshift service apparatus 10 of FIGS. 4 and 5.

Since the step of performing the timeshift service, the step of storing the multimedia stream, and the step of generating the information about the multimedia stream of the multimedia reproducing apparatus 70 are identical to the timeshift service step, the multimedia stream storing step, and the information generating step of the timeshift service apparatus 10 of FIGS. 4 and 5, the detailed information thereof is omitted.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application Nos. 2006-0121437 and 2007-0088332, filed in the Korean Intellectual Property Office on Dec. 4, 2006, and Aug. 31, 2007, the entire contents of which are incorporated herein by reference.

While the present invention has been described with respect to certain preferred embodiments, it will be apparent to those skilled in the art that various changes and modifications may be made without departing from the spirits and scope of the invention as defined in the following claims.

1. A timeshift service apparatus comprising:
a timeshift buffering means for storing a multimedia stream according to a timeshift service request from outside;
a time obtaining means for obtaining time information about a timeshift service start time and a timeshift service end time according to the timeshift service request;
a memory managing means for storing a multimedia stream, which is serviced based on the obtained time information by the time obtaining means, in the timeshift buffering means; and
an information generating means for generating detailed information for the multimedia stream stored in the timeshift buffering means.

2. The timeshift service apparatus of claim 1, wherein the memory managing means begins to store a multimedia stream serviced at the timeshift service start time in the timeshift buffering means and stops storing a multimedia stream in the timeshift buffering means at the timeshift service end time.

3. The timeshift service apparatus of claim 1, wherein the information generating means generates information about each of multimedia streams stored in the timeshift buffering means in a predetermined unit.

4. The timeshift service apparatus of claim 3, wherein the information generating means generates information with time information of each multimedia stream stored in the timeshift buffering means.

5. The timeshift service apparatus of claim 4, wherein the predetermined unit is one of a channel unit, a program unit, and a segment unit.

6. The timeshift service apparatus of claim 1, wherein the time obtaining means regards a timeshift service start time of a multimedia stream stored in the timeshift buffering means as an actual broadcasting start time of a multimedia stream if a timeshift service start time requested by a user is faster than the actual broadcasting start time of a multimedia stream.

7. The timeshift service apparatus of claim 6, wherein if a timeshift service start time requested by the user is later than an actual broadcasting start time of a multimedia stream, the time obtaining means regards the requested timeshift service start time as a timeshift service start time.

8. The timeshift service apparatus of claim 7, wherein if a timeshift service end time requested by the user is faster than an actual broadcasting end time of a multimedia stream, the time obtaining means regards the requested timeshift service end time as a timeshift service end time.

9. The timeshift service apparatus of claim 8, wherein if a timeshift service end time requested by the user is later than an actual broadcasting end time of a multimedia stream, the time obtaining means regards a timeshift service end time for a multimedia stream stored in the timeshift buffering means as an actual broadcasting end time of a multimedia stream.

10. A multimedia reproducing apparatus for a timeshift service, comprising:
a receiving and reproducing means for receiving a multimedia stream and reproducing the received multimedia stream;
a media storing means for storing the received multimedia stream;
a stream analyzing means for obtaining time information about a timeshift service by analyzing the received multimedia stream according to a timeshift service start request, extracting a multimedia stream serviced based on the obtained time information, and storing the extracted multimedia stream in the media storing means;
a media information storing means for storing detailed information for the received multimedia stream; and
an information generating means for generating detailed information for a multimedia stream stored in the media storing means.

11. The multimedia reproducing apparatus of claim 10, wherein the information generating means includes:
an information search unit for searching information about a multimedia stream stored in the media storing means from the media information storing means; and
a controller for generating detailed information for a multimedia stream stored in the media storing means based on detailed information searched by the information search unit.

12. The multimedia reproducing apparatus of claim 11, wherein the controller generates information about each of multimedia streams stored in the media storing means in a predetermined unit.

13. The multimedia reproducing apparatus of claim 12, wherein the controller generates information including time information about each of multimedia streams stored in the media storing means.

14. The multimedia reproducing apparatus of claim 13, wherein the predetermined unit is one of a channel unit, a program unit, and a segment unit.

15. The multimedia reproducing apparatus of claim 10, wherein stream analyzing means obtains a start time and an end time of a timeshift service from the analyzed multimedia stream, starts to store a multimedia stream serviced at the obtained timeshift service start time, and ends to store the multimedia stream at the obtained timeshift service end time.

16. The multimedia reproducing apparatus of claim 15, wherein if a timeshift service start time requested by a user is faster than the actual broadcasting start time of a multimedia stream, the stream analyzing means regards a timeshift service start time of the stored multimedia stream as an actual broadcasting start time of a multimedia stream.

17. The multimedia reproducing apparatus of claim 16, wherein if a timeshift service start time requested by the user is later than an actual broadcasting start time of a multimedia stream, the time obtaining means regards the requested timeshift service start time as a timeshift service start time.

18. The multimedia reproducing apparatus of claim 17, wherein if a timeshift service end time requested by the user is faster than an actual broadcasting end time of a multimedia stream, the time obtaining means regards the requested timeshift service end time as a timeshift service end time.

19. The multimedia reproducing apparatus of claim 18, wherein if a timeshift service end time requested by the user is later than an actual broadcasting end time of a multimedia stream, the time obtaining means regards a timeshift service end time for the stored multimedia stream as an actual broadcasting end time of a multimedia stream.

20. The multimedia reproducing apparatus of claim 19, wherein the receiving and reproducing means includes:
a stream receiver for receiving a multimedia stream in real time; and
a media reproducer for reproducing a multimedia stream received through the stream receiver in real time and reproducing a multimedia stream stored in the media storing means.

21. A timeshift service method comprising the steps of:
obtaining time information about a timeshift service start time and a timeshift service end time according to a timeshift service request;
storing a multimedia stream, which is serviced based on the obtained time information in the obtaining time information; and
generating detailed information for the multimedia stream stored in the storing a multimedia stream.

22. The timeshift service method of claim 21, wherein the storing a multimedia stream includes the steps of:
starting to store a multimedia stream serviced at the obtained timeshift service start time; and
ending to store the multimedia stream at the obtained timeshift service end time.

23. The timeshift service method of claim 21, wherein in the generating detailed information, information about each of multimedia streams is generated in a predetermined unit.

24. The timeshift service method of claim 23, wherein in the generating detailed information, information is generated with time information of each of the stored multimedia streams.

25. The timeshift service method of claim 24, wherein the predetermined unit is one of a channel unit, a program unit, and a segment unit.

26. The timeshift service method of claim 21, wherein in the obtaining time information, if a timeshift service start time requested by a user is faster than an actual broadcasting start time of a multimedia stream, a timeshift service start time of the stored multimedia stream is regarded as an actual broadcasting start time of a multimedia stream.

27. The timeshift service method of claim 26, wherein in the obtaining time information, if a timeshift service start time requested by the user is later than an actual broadcasting start time of a multimedia stream, the requested timeshift service start time is regarded as a timeshift service start time.

28. The timeshift service method of claim 27, wherein in the obtaining time information, if a timeshift service end time requested by the user is faster than an actual broadcasting end time of a multimedia stream, the requested timeshift service end time is regarded as a timeshift service end time.

29. The timeshift service method of claim 28, wherein in the obtaining time information, if a timeshift service end time requested by the user is later than an actual broadcasting end time of a multimedia stream, a timeshift service end time for the stored multimedia stream is regarded as an actual broadcasting end time of a multimedia stream.

30. A method for storing a multimedia stream and generating information thereof for a timeshift service, comprising the steps of:
starting to store a multimedia stream in a timeshift buffering means when a timeshift starts;
generating information of a multimedia stream stored in the timeshift buffering means; and
ending to store a multimedia stream stored in the timeshift buffering means according to a request of ending a timeshift.

31. The method of claim 30, further comprising the step of interrupting to store a multimedia stream stored in the timeshift buffering means according to a request of changing a channel and storing a multimedia stream serviced at the requested channel.

32. The method of claim 30, wherein the generating information includes the steps of:
generating channel information of a multimedia stream stored in the timeshift buffering means; and
generating program information of a multimedia stream stored in the timeshift buffering means.

33. The method of claim 32, wherein in the generating information further includes the step of generating segment information of a multimedia stream stored in the timeshift buffering means.

34. The method of claim 33, wherein the segment information is information about detailed parts of a program of a multimedia stream stored in the timeshift buffering means and includes information about a timeshift segment start time and a timeshift segment end time.

35. The method of claim 33, wherein the channel information is information about a channel of a multimedia stream stored in the timeshift buffering means and includes information about a timeshift channel start time and a timeshift channel end time.

36. The method of claim 33, wherein the program information is information about a program of a multimedia stream stored in the timeshift buffering means and includes information about a timeshift program start time and a timeshift program end time.
